(19) United States
(12) Patent Application Publication
(10) Pub. No.: US 2021/0316922 A1
(43) Pub. Date: Oct. 14, 2021

(54) CASSETTE, CASSETTE SUPPORT SYSTEM AND CONTAINER ASSEMBLY FOR STORING A TUBULAR STORAGE ASSEMBLY

(71) Applicant: Fuji Seal International, Inc., Osaka-shi (JP)

(72) Inventors: Jeroen Gerrit Anton Gebbink, Helmond (NL); Marinus Antonius Leonarda Van Heck, Haarsteeg (NL); Stijn Antonius Petrus Verhoeven, Beek En Donk (NL)

(73) Assignee: Fuji Seal International, Inc., Osaka-shi (JP)

(21) Appl. No.: 17/266,328

(22) PCT Filed: Aug. 8, 2019
(86) PCT No.: PCT/NL2019/050521

§ 371 Date: Feb. 5, 2021

(30) Foreign Application Priority Data
Aug. 8, 2018 (NL) 2021440

(51) Int. Cl. B65D 71/50; B65G 47/51; B65D 75/58; B65D 75/00; B65B 43/14; B65B 43/12

(52) U.S. Cl. CPC B65D 71/50; B65G 47/5104; B65D 75/5883; B65G 2201/0235; B65B 43/14; B65B 43/123; B65D 75/008

(57) ABSTRACT

The present disclosure relates to a cassette for storing a tubular storage assembly, the tubular storage assembly having a plurality of elongated guiding elements onto which containers can be carried, wherein the elongated guiding elements are configured to be maintained in a tubular arrangement, the cassette includes a cassette housing configured to accommodate the tubular storage assembly, the elongated guiding elements of the tubular storage assembly extending in an axial direction of the cassette housing; and a carrier arranged to be movable inside the cassette housing and configured to carry the tubular storage assembly; wherein the cassette housing comprises at least one stop element for stopping movement of the carrier in the axial direction and wherein the carrier and cassette housing are configured to allow the carrier to be essentially freely movable in transverse directions; and wherein the carrier comprises at least one alignment element.

The present disclosure relates to a cassette for storing a tubular storage assembly, the tubular storage assembly comprising a plurality of elongated guiding elements onto which a plurality of rows of containers can be carried. The present disclosure also relates to a cassette support system configured to support at least one cassette, to an assembly of a cassette and an external device and to the use of the cassette (support system) and/or assembly.

Flexible containers for keeping fluid or dry products, such as a liquid, granular material, powder or the like, are known in the art. One example of a flexible container is a flexible pouch container comprising, for instance, a laminate composed of sheets of plastic or the like. For instance, a container may be made of a front and back wall comprising one or more flexible film, facing one another and joined, for example welded, along their edges. The container has a dispensing spout to provide access to the interior of the container and to allow any contents in the container to be dispensed therefrom.

A tubular storage assembly of the type described in the present disclosure has been developed by the same applicant and has been disclosed in the international publication WO 2015/128427 A1. The tubular storage assembly comprises a plurality of elongated guiding elements onto which a plurality of rows of dispensing spouts and associated pouch containers can be carried. The elongated guiding elements are configured to be maintained in a substantially tubular arrangement while the containers extend in the interior formed by the tubular arrangement. In this manner the tubular storage assembly provides for a reliable and efficient means for storage and/or transport of large numbers of pouch containers.

The pouch containers in the tubular storage assembly usually are empty containers. This is because the pouch containers may be manufactured at a location different from the location at which the containers are further handled, for instance filled with contents, such as foodstuff. For instance, the containers may be manufactured at a first location, loaded into the guiding elements, packed, stored and then transported to a second location where they are stored again and then unpacked and unloaded for further handling.

Discharge systems and methods have been developed to unload the pouch containers from a tubular storage assembly. For instance, WO 2017/032470 A1 discloses a discharge system and discharge method wherein the guiding elements of a tubular storage assembly are aligned with respect to a discharge device so that the pouch containers can be pushed out of the tubular storage device right into a discharge device wherein the containers are gripped by a gripper and moved to a discharge position. The known method and system may allow the pouch containers to be discharged in a relatively fast, reliable and/or efficient manner from their tubular storage assemblies.

In the known discharge system and method the tubular storage assemblies arrive on a support platform, for instance the platform shown in FIG. 8 of WO 2015/128427 A1. On this platform a number of tubular storage assemblies has been stacked. Each of the tubular storage assemblies should be taken from this platform and then brought to a storage assembly support. The tubular storage assembly is then placed on this storage assembly support and then the tubular storage assembly is aligned with a discharge device arranged at one end of the tubular storage assembly and with a push device arranged at the opposite end of the tubular storage assembly. However, the handling of the tubular storage assembly in this manner may be complex and require operator intervention.

It has been found beneficial to first arrange the tubular storage assemblies in respective cassettes and to then handle the cassettes instead of directly the tubular storage assemblies. In this manner the arranging of the tubular storage assemblies between the discharge device and push device, the removal thereof once the tubular storage assembly as been fully unloaded and the replacement of the fully unloaded tubular storage assembly by a still loaded tubular storage assembly may be performed more efficiently and in a more reliable manner. Furthermore the handling of the cassettes may be automated more easily, reducing the human operator load.

However, it has been found difficult to properly align the tubular storage assembly in a cassette with respect to an external device, for instance—but not restricted to—a discharge device and/or a push device. For instance, the handling equipment for handling the cassettes may not be able to position the cassette or, more importantly, the tubular storage assembly, with sufficient accuracy with respect to the discharge device and/or push device.

It may be an object of the present disclosure to provide a cassette (system) and/or an assembly of at least one external device and at least one cassette wherein the tubular storage assembly can still be aligned with high accuracy.

It may be another object to provide a cassette (system) and/or an assembly that is just as good as or even improved relative to known discharge systems as concerns speed, reliability and efficiency of discharging the pouch containers from the tubular storage device, while still able to handle the tubular storage assembly in a cassette.

According to a first aspect at least one of the above and/or other objects may be at least partially achieved in a cassette for storing a tubular storage assembly, the tubular storage assembly comprising a plurality of elongated guiding elements onto which a plurality of rows of containers can be carried, wherein the elongated guiding elements are configured to be maintained in a substantially tubular arrangement while the containers extend in the interior formed by the tubular arrangement, the cassette comprising:
a cassette housing configured to accommodate the tubular storage assembly, the elongated guiding elements of the tubular storage assembly extending in the axial direction of the cassette housing;
a carrier arranged to be movable inside the cassette housing and configured to carry the tubular storage assembly;

wherein the cassette housing comprises at least one stop element for stopping movement of the carrier in the axial direction and wherein the carrier and cassette housing are configured to allow the carrier to be essentially freely movable in transverse directions; and

wherein the carrier comprises at least one alignment element, wherein the at least one alignment element is configured to align the movable carrier relative to an external device to be arranged next to the cassette.

The alignment may involve movement of the carrier and the tubular storage assembly supported thereon in transverse direction, irrespective of the position of the cassette housing. For instance, the carrier may be configured to be floatable in the cassette housing. This means that the carrier and the tubular storage assembly supported thereon can be aligned more accurately with respect to an external device than the cassette housing itself. In this manner the advantages of using a cassette for handling a tubular storage assembly can be combined with the accuracy that may be achieved with handling the tubular storage assembly directly (when it is not arranged in a cassette housing).

In an embodiment the at least one alignment element of the carrier may be configured to engage at least one alignment element of the first or second external device. If the carrier is not already in the correct position, the engagement of the alignment elements of the carrier and the external device causes the carrier to move in transversal direction until the correct position has been arrived and the carrier (including the tubular storage assembly supported thereon) is accurately aligned with the external device.

In embodiments of the present disclosure the at least one alignment element of the carrier is an alignment hole configured to receive an alignment pin from the first or second external device. Alternatively or additionally the at least one alignment element of the carrier is an alignment pin configured to be inserted into an alignment hole. Alignment holes can be arranged in at least one of the carrier, first external device and second external device. Similarly, alignment pins can be arranged in at least one of the carrier, first external device and second external device.

The at least one alignment hole may have a lead-in part for guiding the alignment pin to be inserted in the alignment hole. The lead-in part may comprise a chamfered surface, for instance a conical surface. Additionally or alternatively, the at least one alignment pin may have a chamfered part. The chamfered part may be a chamfered outer end of the alignment pin. In certain embodiments the lead-in part of an alignment hole and/or the chamfered part of an alignment pin are configured to (more easily) move the carrier towards a predefined alignment position relative to the first and/or second external device, respectively. The lead-in part of an alignment hole and/or the chamfered part of an alignment pin are configured to move the carrier in transverse direction only, towards the predefined alignment position, substantially independent from the position of the cassette housing.

The alignment pin may be mounted (to an externa device and/or to the carrier) so as to be movable between a retracted position wherein the alignment pin extends outside the associated alignment hole and an alignment position wherein the alignment pin is inserted in the alignment hole. The cassette may comprise a drive mechanism configured to move the alignment pin between the retracted position and the alignment position. In other embodiments this driving mechanism is arranged in at least one of the external devices instead.

The carrier may have a first end face to be arranged next to a first external device and a second end face, opposite the first end face, to be arranged next to a second external device. The first alignment element may be provided in the first end face and a second alignment element may be provided in the second end face so as to align the carrier to both the first external device and the second external device.

In order to restrict or even avoid relative motion of the carrier and cassette housing in axial direction, the cassette housing may comprise a first and second stop element arranged to abut respectively the first and second end face of the carrier. In this manner the carrier is confined between both stop elements.

In embodiments of the present disclosure the cassette comprises a first axial opening in a first end wall of the cassette housing for allowing the discharge of the containers from the cassette and/or a second axial opening in a second end wall of the cassette housing for allowing the application of a pushing force on the containers. The first external device may be a discharge device configured to receive the containers from the tubular storage assembly into a receiving portion and to move the removed containers from the receiving portion towards a discharge portion and/or the second external device may be a push device configured to push the containers and/or the tubular storage device in axial direction.

According to another aspect a cassette support system is provided, the cassette support system being configured to support at least one cassette. The cassette support system further comprises a lift mechanism for lifting at least one cassette of the at least one cassette relative to an external device. The lift mechanism may position the carrier into a first position roughly aligned with the first device. More specifically, the lift mechanism may be configured to lift the cassette housing and the carrier arranged therein so as to position the cassette housing substantially at the same height level as the external device. In a further embodiment the lift mechanism is configured to lift the cassette housing and the carrier arranged therein so as to position the cassette housing substantially at the same height level as the height level of a first external device and a second external device when a first external device is arranged at a first end of the cassette and a second external device is arranged at a second end, opposite the first end, of the cassette. Once the cassette has been lifted to a suitable height, the alignment elements allow movement in transversal direction to bring the carrier into a second position, more accurately aligned with the external device (or with both external devices in case external devices have present at both ends of the cassette).

In case the first and second external devices are a discharge device and push device, the assembly may comprise:
at least one cassette;
a cassette support system configured to support at least one cassette;
a container discharge device including a receiving portion and a discharge portion, the discharge device being arranged opposite an axial opening in the end wall of the cassette housing and being configured to receive containers from the tubular storage assembly in the receiving portion and move the removed containers from the receiving portion towards the discharge portion;

wherein the carrier of the cassette comprises at least one first alignment element and the discharge device comprises at least one second alignment element, wherein the at least one first and second alignment elements are configured to displace the carrier and the tubular storage assembly thereon in transverse direction relative to the cassette housing to align the carrier with the discharge device.

The cassette support system may comprise a lift mechanism in order to move one or more cassettes in upward and/or downward direction, although a different support mechanism is also possible.

In a specific embodiment the assembly comprises a push device arranged opposite a second axial opening in an end wall of the cassette housing and configured to apply a pushing force on the containers, wherein the carrier comprises at least one third alignment element and the push device comprises at least one fourth alignment element, wherein the at least one third and fourth alignment elements are configured to displace the carrier and the tubular storage assembly thereon in transverse direction relative to the cassette housing to align the carrier with the push device. The push device may further be configured to move the containers into the receiving portion of the discharge device.

More specifically, the discharge device may comprise:
a gripper unit;
a drive configured to cause the storage assembly support and the gripper unit to rotate relative to each other;
   wherein the gripper unit is configured to grip dispensing spouts of containers moved into the discharge device and successively passing by the gripper unit, to transport the gripped dispensing spouts and associated containers in essentially the axial direction and to collect the dispensing spouts at the discharge portion.

The present disclosure also relates to the use of the cassette, the cassette system and/or the assembly as defined herein.

Further characteristics of the present invention will be elucidated in the accompanying description of various preferred embodiments thereof. In the description reference is made to the annexed figures.

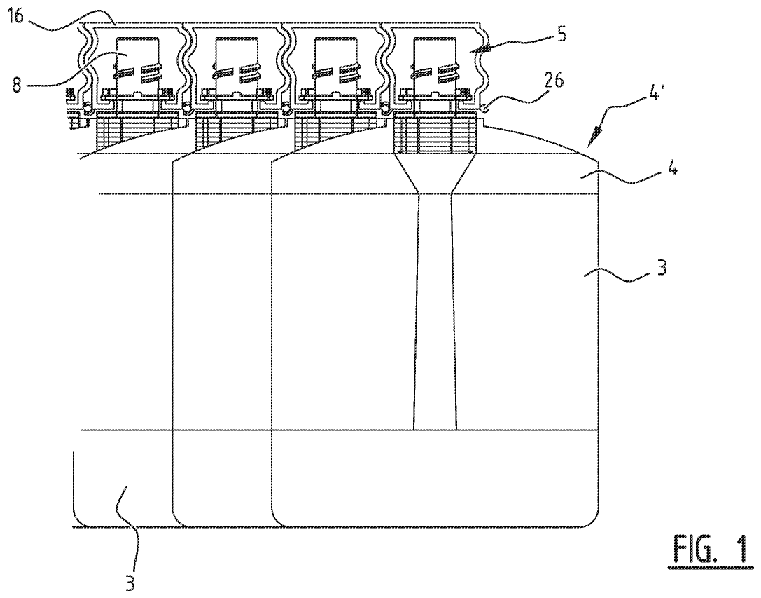

FIG. 1 is a schematic view of an exemplifying container used in an assembly according to an embodiment of the present invention;

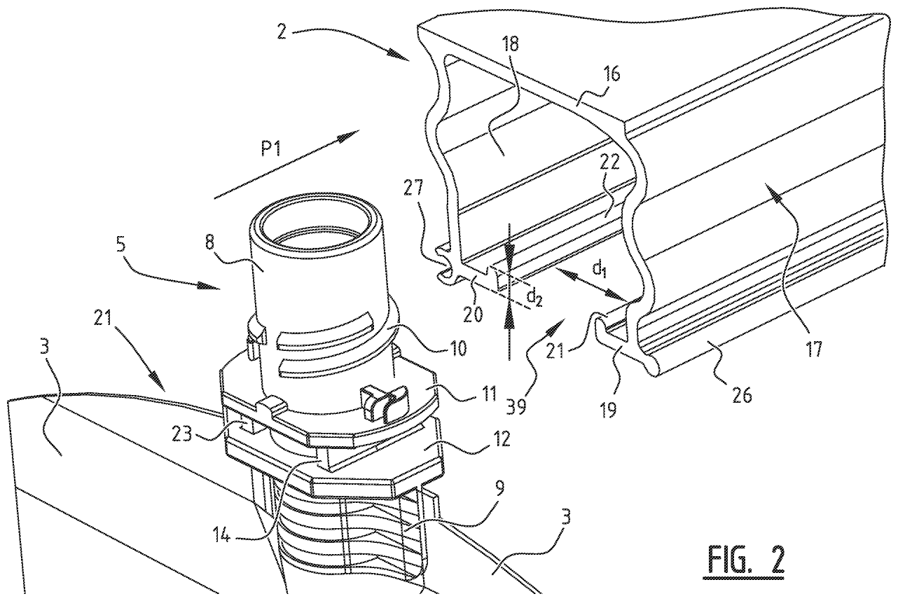

FIG. 2 is a combination of the container of FIG. 1 and an embodiment of a guiding element;

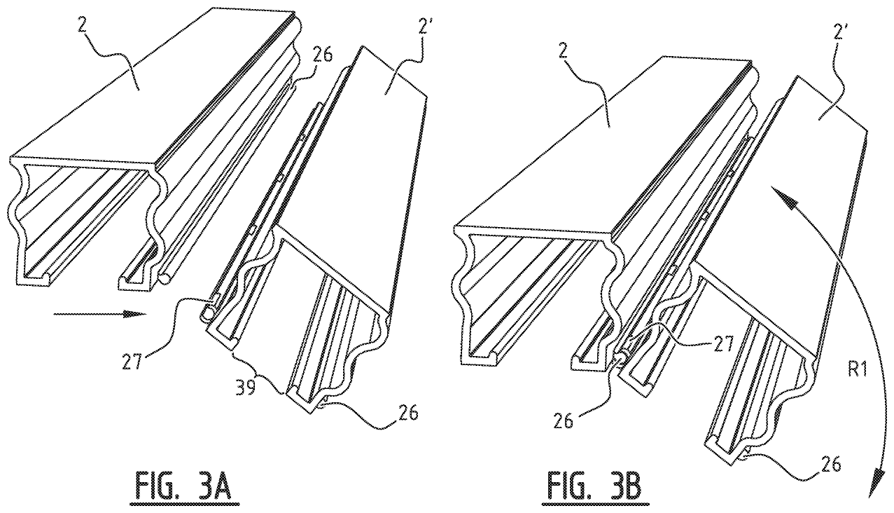

FIGS. 3A and 3B are perspective views of the guiding elements in disconnected and connected condition, respectively;

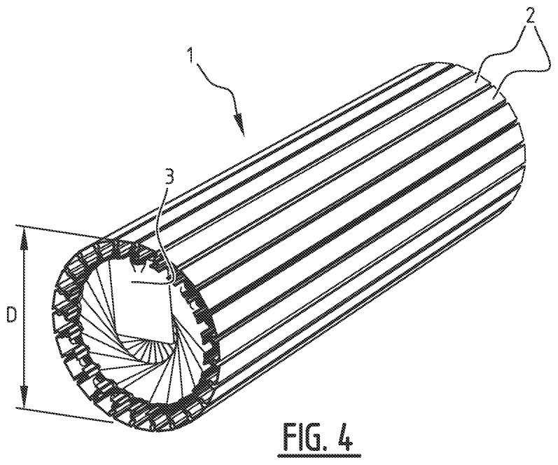

FIG. 4 is a side view of the tubular storage assembly in its predetermined target arrangement, loaded with a large number of spouted pouch containers;

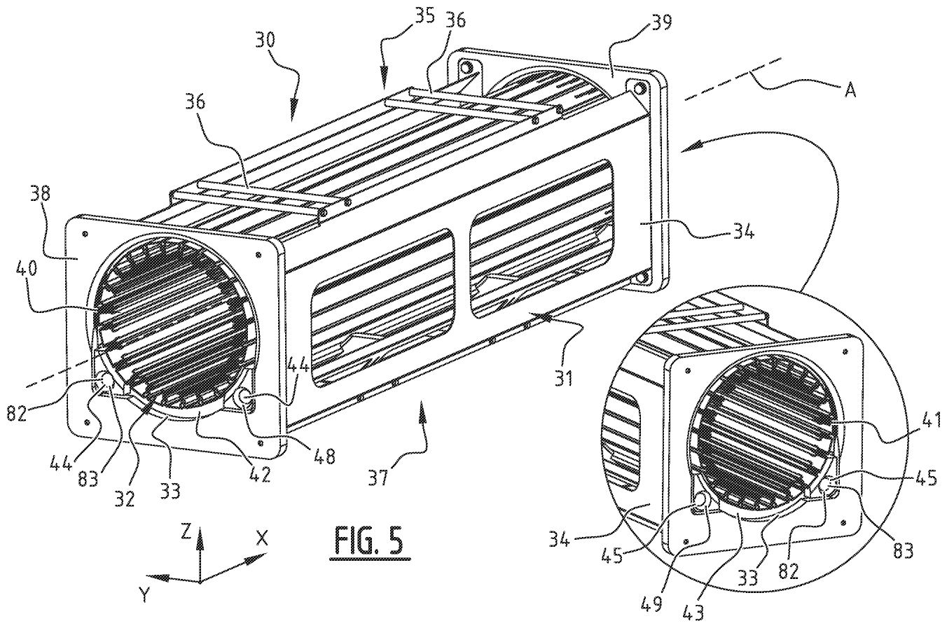

FIG. 5 is a side view and a detailed view of an embodiment of a cassette for holding a tubular storage assembly;

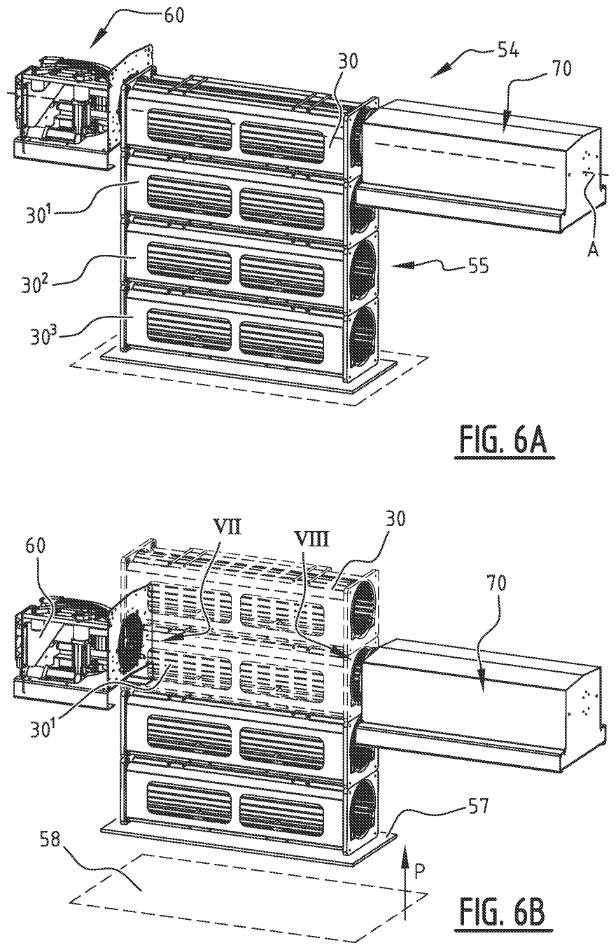

FIGS. 6A and 6B side views of an embodiment of an assembly comprising a cassette system, a discharge device and a push device;

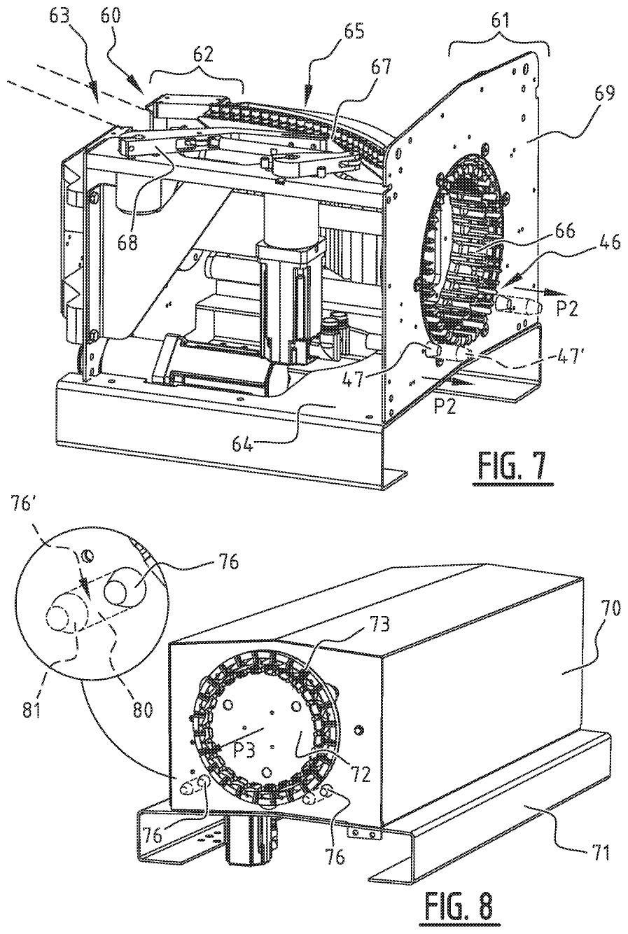

FIG. 7 a partly taken away side view of an embodiment of a discharge device including alignment elements;

FIG. 8 a partly taken away side view of an embodiment of a push device including alignment elements;

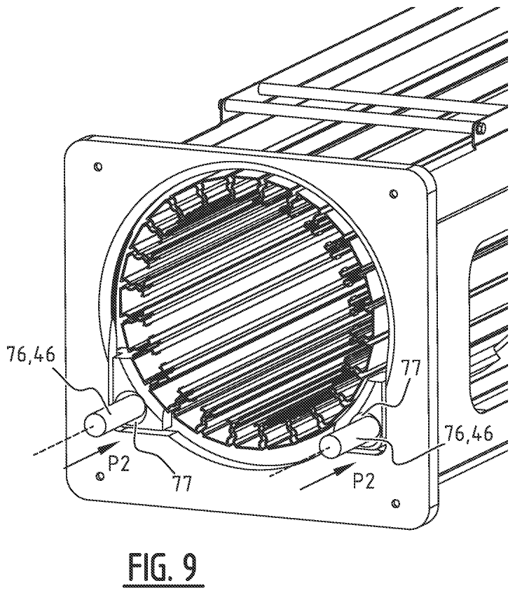

FIG. 9 a partly taken away side view one of the ends of the cassette according to FIG. 5;

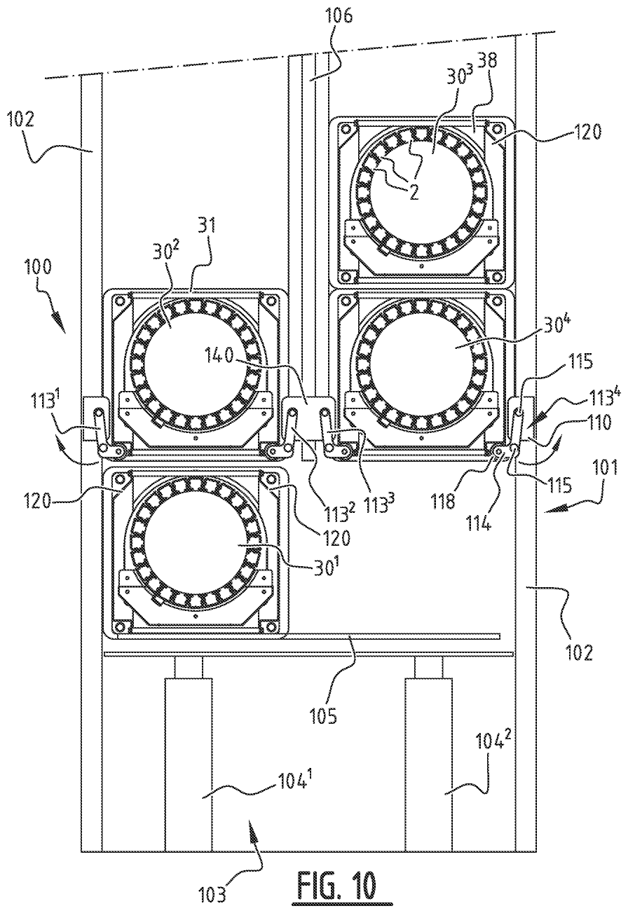

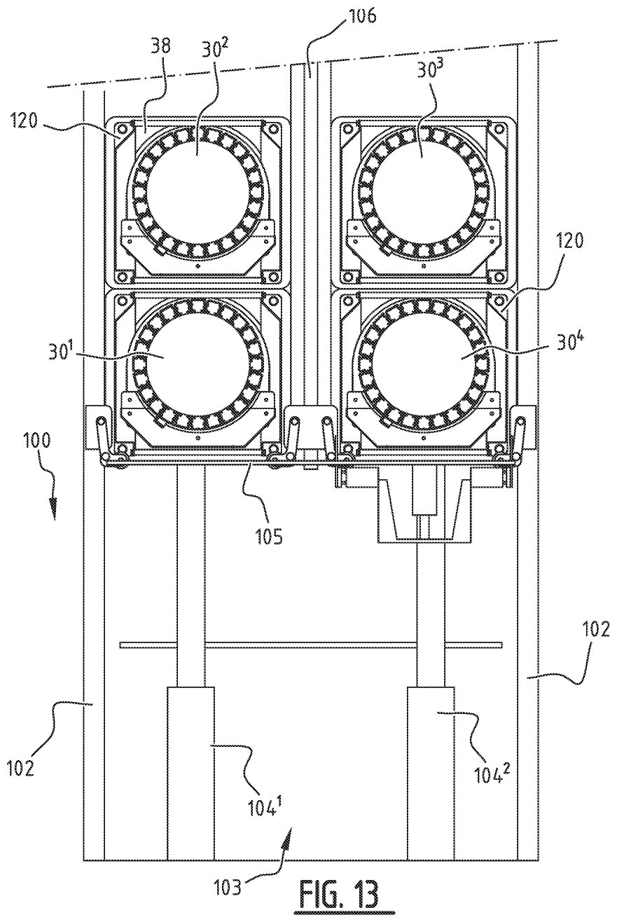

FIGS. 10-18 a number of partly taken away front views of an embodiment of a container support system comprising a carousel-type lift mechanism, in respective phases of the lifting operation.

In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily obscuring the present invention.

As will be apparent to those of skill in the art upon reading this disclosure, each of the individual embodiments described and illustrated herein has discrete components and features which may be readily separated from or combined with the features of any of the other several embodiments without departing from the scope of the present invention. Any recited method can be carried out in the order of events recited or in any other order which is logically possible

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

In the following description several embodiments of a discharge system are described. Each discharge system generally comprises a tubular storage assembly support configured to carry one or more tubular storage assemblies, a discharge device configured to discharge the pouch containers 3 from a discharge end of the tubular storage assembly 1 and, optionally, a push device configured to push the pouch containers 3 towards the discharge device.

As herein defined the tubular storage assembly 1 may be an assembly of guiding elements 2 placed in such arrangement that they define the shape of a tube. Herein the tubular storage assembly 1 may therefore also be denoted by the term “tubular arrangement”. Each of the guiding elements 2 of the tubular storage assembly 1 is configured to allow guiding of one or more pouch containers 3 so that the pouch containers 3 may be stored inside the interior formed by the combination of guiding elements 2. Several examples of a tubular storage assembly 1 are described hereafter that may be unloaded by a discharge device 60, for instance a discharge device as described in WO 2017/032470 A1, the content of which is herein incorporated by reference.

FIG. 1 shows a number of pouch containers 3 (herein also referred to as “pouches” or “containers”), comprising a front wall 4 and a back wall 4′, both walls being made of thin, flexible film material, preferably plastic film material. The walls 4, 4′ are sealed along their circumferential edges to form a package for flowable products, for example foodstuff, cosmetics, medicines, etc. In the upper edge of the pouch container a dispensing element, herein also referred to as a (dispensing) spout 5, is arranged.

Referring to FIG. 2, the spout 5 of the pouch container 3 comprises an elongated dispensing tube 8. The upper end of the dispensing tube 8 is provided with thread windings 10 for attaching a removable end cap (not shown) on the pouch container 3 after it has been filled. The lower end of the dispensing tube 8 extends through the upper circumferential edge and extends into the interior thereof so that the dispensing tube 8 may provide a fluid connection between the interior of the pouch container 3 and its surroundings so that the content of the pouch 3 may be dispensed when the end cap is removed. The dispensing tube 8 is provided with two lateral elements which serve to attach the pouch container 3 to a guiding element 2. More specifically, the dispensing tube 8 comprises an upper flange part 11 and a lower flange part 12.

Guiding rail or guiding element 2 is an elongated section comprising an upper part 16, a first side wall 17 and a second side wall 18, both side parts extending roughly orthogonally with respect to the upper part 16. At the free ends of the side walls 17, 18 a slotted carrier part for carrying the spout 5 of a spouted pouch 3 is provided. The carrier part comprises inwardly extending section flanges 19, 20 forming a slot or channel 39 between the free ends of the flanges 19, 20. The distance (d₁) between the section flange 19 of the first side wall 17 and section flange 20 of the second side wall 18 is slightly larger than the distance between upright walls 14,23 of the spout 5 and smaller than the width of the upper flange part 11 and lower flange part 12 of the spout 5. Furthermore the section flanges 19, 20 are provided at their respective outer ends with longitudinal ridges 21, 22 along which the upper flange part 11 of the dispensing element (spout 5) of the pouch container 3 can be slid. The distance between the upper flange part 11 and the lower flange part 12 of the spout 5 is slightly larger than the distance d₂ between the top and bottom of a longitudinal ridge 21,22 and such that the longitudinal ridges 21, 22 are properly maintained between the upper flange part 11 and lower flange part 12. Therefore the pouch container 3 can be moved easily into the guiding element 2 by sliding the spout 5 smoothly (in direction P₁) to be stably maintained within the guiding element 2 by the both flange parts 11, 12 of the spout 5 and the section flanges 19, 20 of the guiding element 2. The number of pouch containers 3 that can be arranged in the guiding element 2 depends amongst others on the length of the guiding element 2 and the dimensions of the respective spouts 5 of the pouches 3. As a not limiting example a typical guiding element 2 may carry between 50 and 60 pouches.

Referring to FIGS. 2 and 3A-B the first side wall 17 of the guiding element 2 is also provided with an outwardly extending flange forming a male coupling element 26. Similarly the second side wall 18 of the guiding element 2 comprises a female coupling element 27. The male and female coupling elements 26, 27 extend along at least a substantial part of the length of the guiding element 2 and are dimensioned in such a way that the male coupling element 26 of a first guiding element 2 can be inserted into the female coupling element 27 of a second guiding element 2′ to mutually connect the first and second guiding elements 2, 2′. The coupling elements 26, 27 are configured to connect two or more parallel guiding elements 2, 2′, while still allowing the guiding elements 2, 2′ to be moved, more specifically to be pivoted, relative to one another (pivoted in directions R₁, FIG. 3B). Once guiding elements 2, 2′ have been mutually connected, they may still be pivoted relative to each other so that they can be positioned in different arrangements. For instance, the guiding elements 2 may be positioned or folded into the above mentioned tubular arrangement when guiding elements are connected to other guiding elements.

When the guiding elements 2 are pivoted into the tubular arrangement, the last two guiding elements may be connected to each other as well, resulting in the tubular arrangement of the tubular storage assembly 1 as shown in FIG. 4. The guiding elements arranged in the tubular arrangement of self-maintaining (or self-supporting) so that the guiding elements 2 can be coupled in such a manner, that they are mutually supported and that they more a less remain in a tubular arrangement.

Referring to FIG. 4, a tubular storage assembly 1 is shown comprising a plurality of guiding elements 2 (i.e. guiding elements 2 that have been interconnected as described above or, in other embodiments, guiding elements 2 that remain unconnected and are held in the tubular arrangement by external means such as a cover or tube arranged around the guiding elements 2). The guiding elements 2 have been loaded with a large number of (empty) containers 3. The figure shows that the spouted pouch containers 3 have been inserted into the tube-like arrangement in such a manner that they extend in a generally helical trajectory along the length of the guiding elements 2. In other words, in order to optimize the use of the space available in the interior of the tubular storage assembly 1, the containers 3 may be arranged in the tubular arrangement in angularly displaced positions.

The number of guiding elements 2 of the tubular arrangement may vary. Generally the number of guiding elements 2 is n, wherein n=1, 2, 3, 4 . . . . Furthermore, not all guiding elements 2 need to be filled with containers 3. In embodiments of the invention only a subset of the guiding elements 2 is selectively filled, for instance six or twelve of a total number of 24 guiding elements 2, depending on the shape and/or size of the containers 3, for instance with a view to provide for a compact storage.

In a typical (but non-limiting) example 24 containers per rotation (revolution) can be accommodated in the tubular arrangement. Depending on the length of the guiding elements 2 and the dimensions of the containers 3 about 53 rotations can be accommodated in the tubular arrangement. This means that the storage capacity of one tubular storage assembly 1 can be as high as 1272 containers.

Once the tubular storage assemblies 1 have arrived at the site where they are to be unloaded, they may be arranged in cassettes 30. An embodiment of a cassette 30 is shown in FIG. 5. The figure shows a cassette 30 comprising a cassette housing 31 configured to accommodate the tubular storage assembly 1. The cassette housing 31 may have the shape of a rectangular cuboid. More specifically, the cassette housing 31 has an elongated shape so as to be able to accommodate the elongated guiding elements 2 of the tubular storage assembly 1. The elongated guiding elements 2 extend in the axial direction (A, FIG. 5) of the cassette housing 31.

Various embodiments of a cassette comprised of a housing and a movable carried arranged in the housing are conceivable. In embodiments of the present disclosure the cassette housing comprises a first end wall, a second end wall opposite the first end wall, and one or more cassette housing elements connected or formed between the first and second end walls. At least one of the cassette housing elements may be formed by a wall, bar, rod or the like. For instance, referring to FIG. 5, the cassette housing 31 may comprise a first end wall 38, a second end wall 39, two side walls 34,35, a top rod 36 and a bottom rod 37. In other embodiments, for instance, the cassette housing elements are formed by walls substantially surrounding a tubular storage assembly, thereby providing even more protection for the tubular storage assembly from external impact. Furthermore, the cassettes may be configured to be portable (as a whole, with the tubular storage assembly positioned on the carrier inside the housing). Alternatively or additionally, the cassette may be configured to be stackable so that a number of cassettes may be stably positioned one on top of the other. An example of a stackable cassette may be the above-mentioned cassette with the rectangular cuboid housing.

Returning to the embodiment of FIG. 5, in both the first end wall 38 and the second end wall 39 axial openings have been provided (slightly larger in diameter than the diameter (D) of the tubular storage assembly 1 as shown in FIG. 4). A first axial opening 40 in the first end wall 38 of the cassette housing 31 for allowing the discharge of the containers 3 from the cassette 30 and a second axial opening 41 in the second end wall 39 of the cassette housing 31 for allowing the application of a pushing force on the containers 3, as will be explained hereafter.

The tubular storage assembly 1 has been placed on an elongated carrier 32 (hatched part, FIG. 5) arranged inside the cassette housing 31. The carrier 32 is configured (size and shape, the carrier comprising one or more curved support surfaces to support the curved outer surface of the tubular storage assembly 1) to stably carry the tubular storage assembly 1. However, the carrier 32 is essentially freely movable (at least to some extent, for instance a few millimeters or centimeters) in transverse directions (T) relative to the axial direction (A) while its movement in axial direction is limited. In some embodiments essentially no movement in axial direction (A) is possible. In other words, if throughout the present disclosure, the axial direction (A) corresponds to the x-direction, the transverse horizontal direction corresponds to the y-direction and the transverse vertical direction corresponds to the z-direction, the carrier 32 can only be moved (shifted) in the y- and z-directions, not in the x-directions.

In order to confine the carrier 32 inside the cassette housing 31 in both axial directions the cassette housing 31 comprises one or more stop elements. In the embodiment shown in FIG. 5 the cassette housing 31 has two stop elements: the first stop element is formed by the first end wall 38 and the second stop element is formed by the second end wall 39. As can be seen in FIG. 5, the carrier 32 is slightly recessed relative to the lower circumferential edge 33 around the axial opening 40,41 in each of the end walls 38, 39. Furthermore, the carrier 32 abuts the inner surfaces of both the first and second end wall 38,39. Consequently, in the shown embodiment, the carrier 32 is confined between the end walls 38, 39 of the cassette housing 31 and essentially cannot move in axial direction (A) relative to the cassette housing 31.

The carrier 32 may remain unattached to the cassette housing 31 other than both end walls 38, 39, as long as it is maintained between both walls 38, 39 in axial direction (A). However, the carrier 32 may be moved with respect to the cassette housing 31 in any transverse direction (or, in other words, the carrier may be freely moved in the z- and y-directions).

Furthermore, the carrier 32 has a first (carrier) end face 42 and a second (carrier) end face 43, opposite the first end face 42. In the embodiment shown in FIG. 5 first alignment elements 44 are provided in the first end face 42 and second alignment elements 45 are provided in the second end face 43 of the carrier 32. More specifically, the alignment elements 44, 45 in the end faces 42, 43 of the carrier 32 are alignment holes 48 configured to receive therein an associated alignment pin (47, FIG. 7) from one or more external devices located next to the cassette 30.

The external device could be a container discharge device 60 and a push device 70 as shown in FIGS. 6A, 6B,7-9. FIG. 6A shows an embodiment of an assembly 54 comprising a cassette support system 55 configured to support at least one cassette 30. The number of cassettes 30 may be four (cassettes 30,30¹,30², 30³ as shown in FIG. 6A and in FIGS. 10-18), but may be smaller (1-3) or larger (5, 6, 7,8,9,10, . . . )). The cassettes 30 may be stacked on top of each other or may be arranged in a different manner relative to each other. Furthermore, the cassette support system 55 may comprise a stationary support, arranged on a support surface 58 such as a floor, but may also comprise a movable support, for instance a support mounted on a carriage or cart that may be driven over the floor or a support arranged in a caroussel system, for instance the caroussel system shown in FIGS. 10-18).

The cassette support system 55 may comprise a lift mechanism 56 having a platform 57 on which the cassettes 30 are stacked. The lift mechanism 56 may be configured to move the stack of cassettes 30,30¹,30²,30³ in upward and downward direction (P, see FIG. 6B). For instance, in FIG. 6A the situation is depicted wherein a first cassette 30 is aligned with the discharge device 60 and the push device 70, whereas in FIG. 6B the stack of cassettes 30 has moved upward and a second cassette 30′ is (to be) aligned with the discharge device 60 and the push device 70.

Examples of discharge devices 60 are described in WO 2017/032470 A1 and EP 3 225 573 A1, the content of which is herein incorporated by reference. Furthermore, FIG. 7 shows an embodiment of such discharge device 60 in more detail. The discharge device 60 is positioned next to (i.e. opposite to) the first end wall 38 of the cassette housing 31. The discharge device 60 is configured to receive through its receiving portion 61 the containers 3 that have been displaced in axial direction by the push device 70 from the tubular storage assembly 1 and to move the containers 3 one by one towards a discharge portion 62 of the discharge device 60 in a discharge area of the discharge system where the pouch containers 3 are collected for further transport. The discharge device 60 can be connected or associated with any output device, for instance an outfeed lane 63, for further transport of the pouch containers 3, for instance in the direction of one or more handling stations. In the figure outfeed lane 63 has been schematically shown in dotted lines in order to make clear that in fact any type of output device can be used to discharge the pouch containers 3 from the discharge area of the discharge device 60.

FIG. 7 shows a stationary frame 64 in which a rotor or rotatable gripper unit 65 comprising a rotatable gripper support 66 and a slotted gripper 67 is mounted. The rotatable gripper support 66 can be driven by a drive, for instance an electric motor connected to the stationary frame 64. As described in WO 2017/032470 A1, the rotatable gripper support 66 may be configured to grip (during rotation thereof relative to the stationary tubular storage assembly 1) one by one the spouts 5 of consecutive containers 3 and carry them in the slot provided therein. Once a sufficient number of pouch containers 3 has been gripped and collected in the slot of the slotted gripper 67, the rotation of the slotted gripper 67 is interrupted and a rotatable sweeper arm 68 (that is rotatably mounted to the stationary frame 64) is controlled to move the collected containers 3 towards the outfeed lane 63.

In order to receive the containers 3 in a reliable manner the channels 39 in the guiding elements 2 should be accurately aligned with the receiving portion 61 of the discharge device 60, more specifically with the rotatable gripper unit 65. More specifically, the lift mechanism 56 is able to transport the cassette 30 including the carrier 32 on which the tubular storage assembly 1 rests to a first position wherein the carrier 32 is roughly in line with the discharge device 60. Typically, the lift mechanism 56 is able to align the carrier 32 with an accuracy of +/−4 mm in y-direction and 4 mm in x-direction. This accuracy may not be sufficient for the alignment of the carrier 32 and thereby the alignment of the tubular storage assembly 1 with respect to the discharge device 60. Typically the latter, higher accuracy (of the carrier) should be in the range of +/−2 mm.

According to embodiments of the present disclosure the accuracy of the positioning of the carrier 32 may be improved by the alignment elements 44 (and alignment elements 45 as well) in the carrier 32 and the associated alignment elements 46 in the front wall 69 of the discharge device 60. In the embodiment shown in the figures the alignment elements 44 of the cassette 32 are alignment holes 48 and the alignment elements 46 of the discharge device 60 are alignment pins 47.

The alignment pins 47 may be mounted in such a manner to the discharge device 60 that they can be moved from a retracted position (pin 47, solid lines, figurer 7, wherein the alignment pin 47 is retracted and therefore extends outside the associated alignment hole 48) in direction P₂ (FIGS. 7 and 9) to an alignment position (pin 47′, dotted lines, wherein the alignment pin 47 are inserted in the alignment holes 48).

The alignment elements 44, 45, 46 (alignment pins 47 and alignment holes 48) are configured to displace the carrier 32 and the tubular storage assembly 1 thereon in transverse direction relative to the cassette housing 31 and the discharge device 60 during the insertion the alignment pins 47 in order to more accurately align the carrier 32 relative to the discharge device 60.

The movement of the retractable alignment pins 47 between the alignment position and the retracted position can be done manually and/or by using a drive mechanism (for instance an electric motor, not shown in the figures).

Although in the shown embodiments the alignment elements 46 of the discharge device 60 are alignment pins 47 and the alignment elements 44, 45 in the carrier 32 are alignment holes 48, this could also be (partially) the opposite. For instance, in other embodiments, the alignment elements 46 of the discharge device 60 are alignment holes and the alignment elements 44, 45 of the carrier 32 are alignment pins. In still other embodiments both the carrier 32 and the discharge device 60 may have a combination of one or more alignment pins and one or more alignment holes.

The second external device arranged next to the opposite end of the cassette 30 may be a so-called push device 70. Examples of push devices 70 are described in documents WO 2017/032470 A1 and EP 3 225 573 A1 as well. FIG. 8 shows an embodiment of such push device 70 in more detail.

The push device 70 may be positioned next to (i.e. opposite to) the second end wall 39 of the cassette housing 31. The push device 70 may comprise a stationary frame 71 for carrying a pusher element 72 having a number of radial pins 73 configured to engage one or more pouch containers 3 of the tubular storage assembly 1 and push them in the direction of the discharge device 60 (axial direction P₃, FIG. 8). The pusher element 72 may be pushed in axial direction by a linear actuator, thereby pushing the pouch containers 3 arranged in the tubular storage assembly 1 along the guiding elements 2 in axial direction towards the opposite end thereof. By moving the pouch containers 3 in axial direction, the containers 3 located in the tubular storage assembly 1 are moved from the tubular storage assembly 1 into the receiving portion 61 of the discharge device 60, if the carrier 32 is correctly and accurately aligned with the discharge device 60 be using the earlier mentioned alignment elements 44, 45, 46.

In some embodiments it may be sufficient to align the cassette housing 31 with the push device 70 in a less accurate manner (for instance by using the lift mechanism 56 only). However, in the embodiments shown in the figures, the alignment accuracy is increased by using similar alignment elements in the second end face 43 of the carrier 32 as were used in the first end face 42. Referring to FIG. 8, the push device 70 may be provided with two retractable alignment pins 76 that may be moved between a retracted position (cf. reference number 76) and an alignment position (cf. reference number 76′).

As shown in FIG. 8, the alignment pins 76 of the push device 70 (and also the alignment pins of the discharge device and/or the carrier of the cassette 30) may have a chamfered part 81 and a straight part 80. Similarly, the alignment elements 45 (i.e. the alignment holes 49) may have a lead-in part 82 (FIG. 5) and a straight part 83, wherein the lead-in part 82 (preferably in combination with the chamfered part 81 of the alignment pins) is able to better guide the alignment pin 76 to be inserted in the alignment hole 48 The lead-in part 82 of the alignment hole 48 may comprise a chamfered surface, for instance a conical surface.

According to another aspect a lift mechanism is provided wherein a number of cassettes 30 (for instance 10 cassettes, but this number could be smaller or higher) can be lifted and lowered in an easy and simple manner, so that a cassette 30 with an unloaded tubular storage assembly 1 can be replaced by a fully loaded one, in a fast and reliable manner and essentially without needing any human intervention.

According to an aspect of the present disclosure a cassette support system for supporting a plurality of cassettes may be provided with a lift mechanism configured to make it possible to successively present the cassettes to one or more unloading positions next to one or more respective discharge devices. FIGS. 10-18 show a particular embodiment of a cassette support system formed by a carousel-type of lift system 100 for carrying a number of cassettes 30 (i.e. four cassettes 30¹,30²,30³,30⁴ in the shown embodiment, but the number of cassettes may be smaller or larger as well). The lift system 100 comprises a frame 101 that is placed on a movable cart (not shown in the figures) or directly onto the floor. The frame 101 comprises a number of upright frame parts 102,106 forming an enclosure for carrying a number of stacked cassettes (wherein the cassettes are stacked in two cassette stacks, a left-hand stack and a right-hand stack). The lowermost cassette 30¹ (herein referred to as the first cassette) in the left-hand cassette stack is directly placed on a liftable platform 105 of a lift mechanism 103. The other cassettes 30² and 30⁴ (herein also referred to as the second and fourth cassette) are supported instead on a number of support brackets 113, while the third cassette 30³ is supported on top of the fourth cassette 30⁴.

More specifically, the second cassette 30² is supported on at least one pair of brackets 113¹ and 113² provided sideways of the cassette's longitudinal side surface, while the fourth cassette 30⁴ is supported on at least one pair of brackets 113³ and 113⁴. Each of the brackets 113¹-113⁴ comprises a generally L-shaped arm 114 that is pivotably connected (through a pivot 115) to a respective support element 110 mounted to any one of the upright frame parts 102 and the central upright frame part 106. The L-shaped arm 114 of a bracket is spring mounted in such a manner that the arm 114 is urged to pivot to a closed, supporting position, as is shown (for instance) in FIG. 10. In the supporting position the bracket 113¹-113⁴ supports the bottom side of a cassette so that the cassette does not move downward under the influence of gravity.

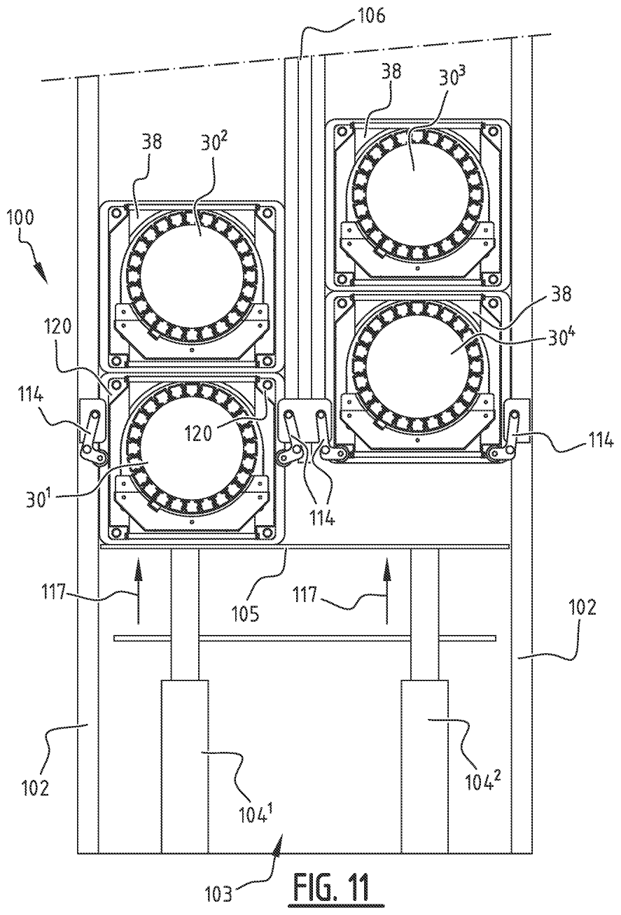

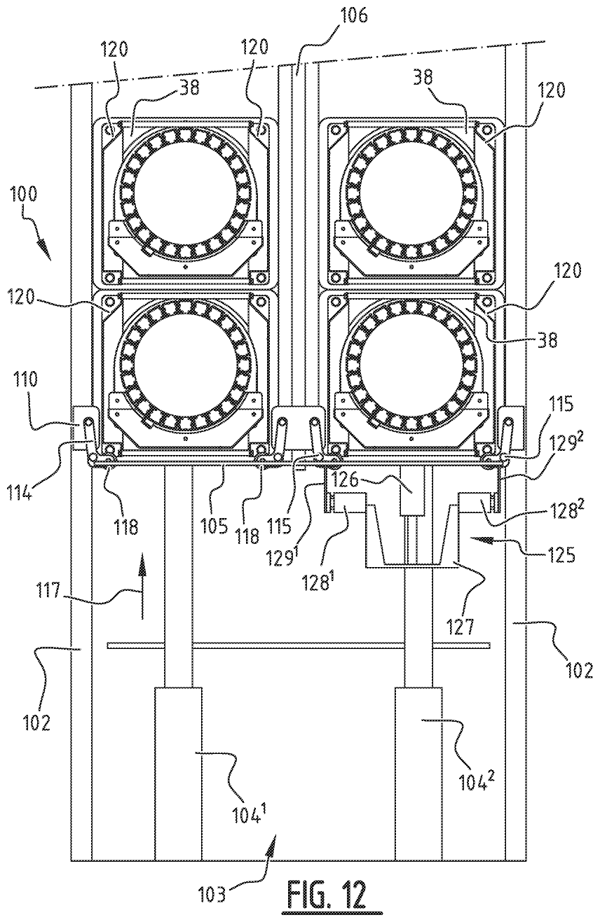

The lift mechanism 103 comprises a number of actuators 104¹,104², for instance comprising hydraulic cylinders, electric motors etc.) that are configured to move the platform 105 upward and downward while keeping the platform in horizontal orientation. When the platform 105 is moved upward (direction 117, FIG. 12), the cassette 30¹ and the cassette 30² carried thereon are moved in upward direction as well. While the lowermost cassette 30¹ is moved upwards, the oblique side surfaces 120 of its cassette housing 31 are pushed against roller 118 provided at the free ends of the L-shaped arms 114 so as to force the brackets 113¹ and 113² to pivot from their closed, supporting position shown in FIG. 10 towards an open position (for the first bracket 113¹) shown in FIG. 11, in which open position the cassette 30¹ may pass the supporting bracket with which the second cassette 30² was supported. The cassettes 30³,30⁴ at the right hand side are still supported on the brackets 113³ and 113⁴, as is shown in FIG. 11 as well.

Starting from the situation of FIG. 11 the platform 105 is moved further in upward direction until the situation of FIG. 12 is reached wherein the platform 105 has moved to abut the bottom side of the lower right (fourth) cassette 30⁴. When this position has been reached, an opening mechanism 125 is actuated to open the brackets 113³ and 113⁴. The opening mechanism 125 may comprise an actuator 126 configured to move a base element 127 upward until a pair of upright opening pins 129¹,129² are moved to engage engagement pins 115 of the left bracket 113³ and right bracket 113⁴, respectively, as is shown in FIGS. 11-13. In the meantime the lower left cassette 30¹ has reached a position wherein the left pair of brackets 113¹ and 113² are automatically moved from their open position to their closed, supporting position (because of the springs that urge the respective L-shaped arms to pivot to the closed position) so that cassette 30¹ (and the cassette 30² carried thereon) can be kept in place by their brackets and do not need to be supported anymore by the platform 105.

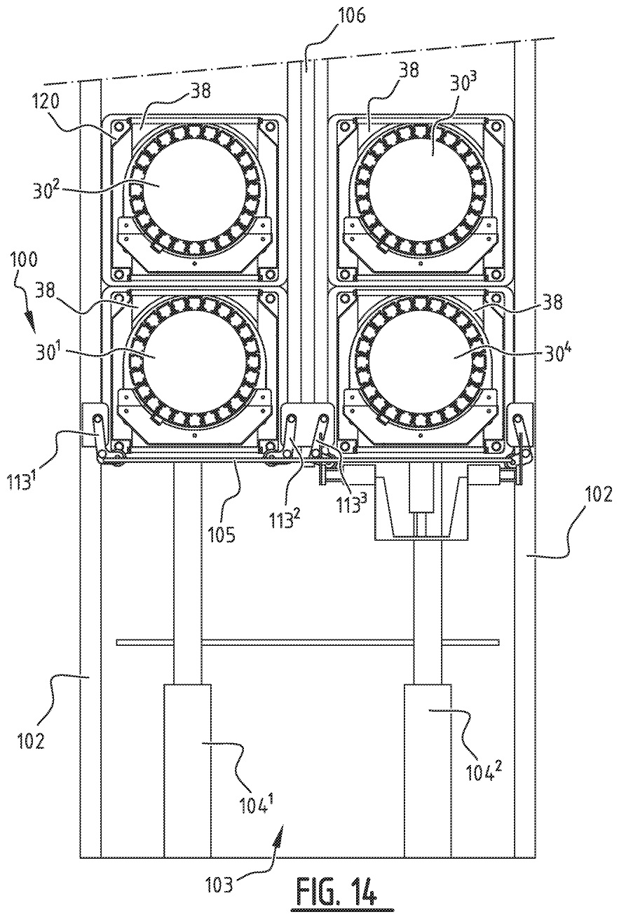

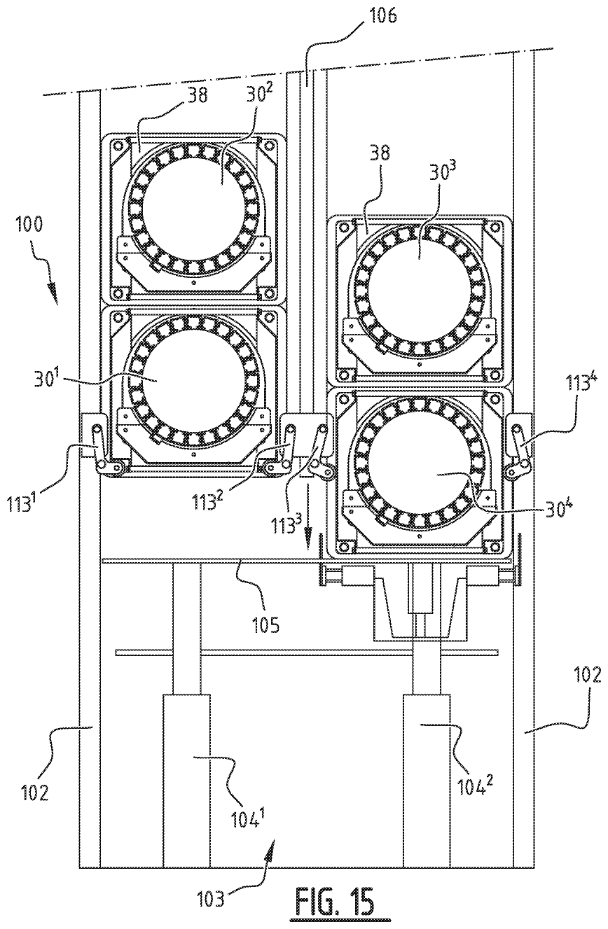

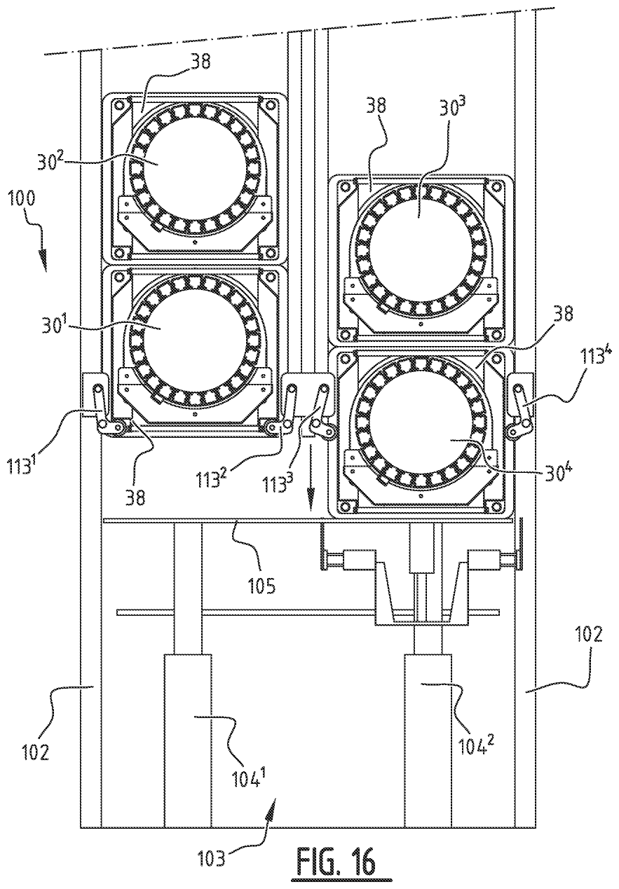

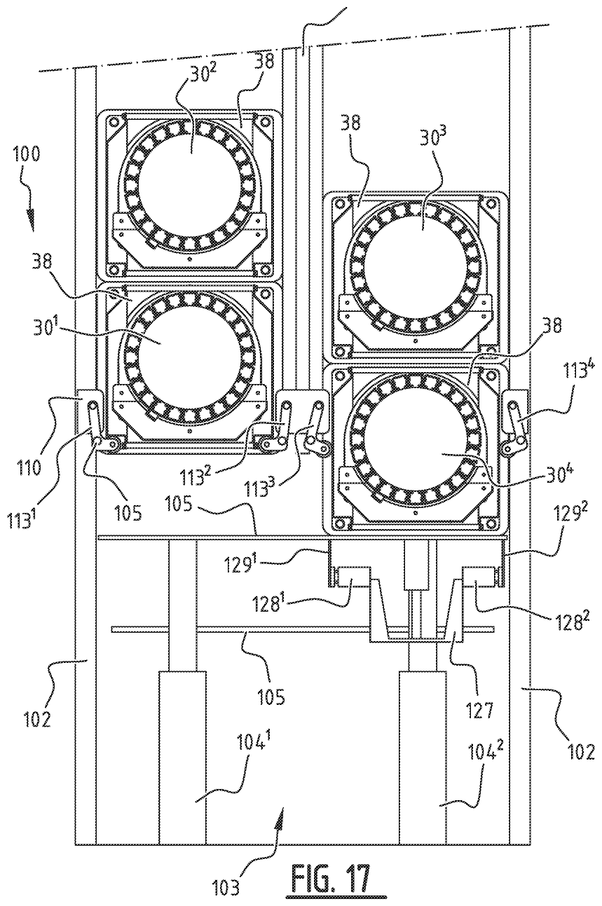

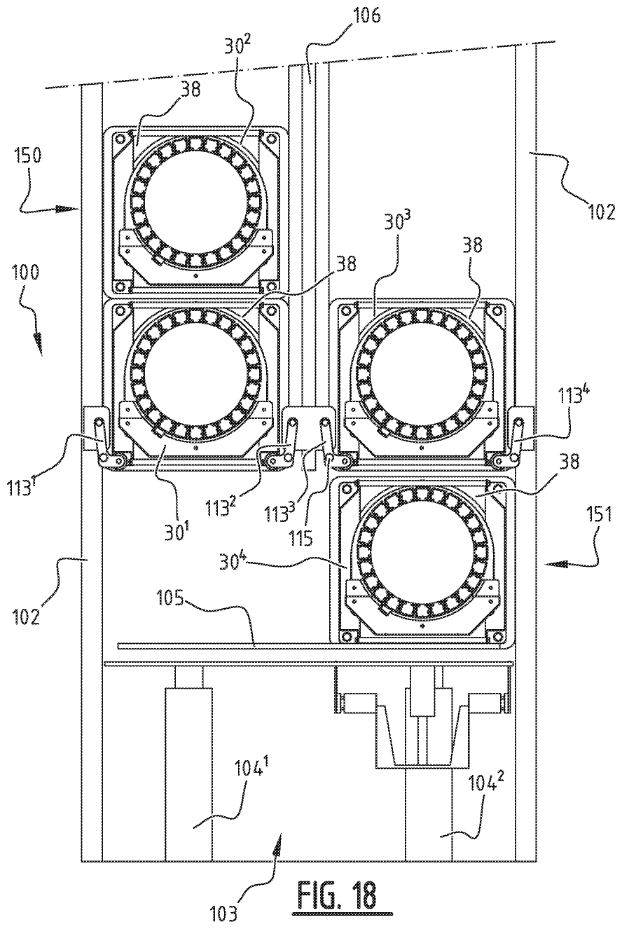

Once opening pins 129¹,129² are moved in outward directions using drive elements 128¹ and 128² so that the associated brackets 113³ and 113⁴ are moved against the spring-action towards their open positions, as is shown in FIG. 14, The platform 105 now can be moved downward again, as is shown in FIGS. 15 and 16, The opening pins 129¹,129² are retracted to their original position until the position of FIG. 18 is reached. In this position the two leftmost cassettes 30¹,30² are carried on the supporting brackets 113¹ and 113², the upper right cassette 30² is carried by brackets 113³ and 113⁴ and the lower right cassette 30⁴ is carried on the platform 105. In this situation the second cassette 30² in the left-hand stack may be pushed in lateral direction by an upper lateral displacement unit (not shown in the figures) in to a location on top of cassette 30³ (in the right-hand stack), while a lower lateral displacement unit pushes the fourth cassette 30⁴ present in the right-hand stack in opposite lateral direction to a location beneath the first container 30¹ in the left-hand stack. The lift system 100 therefore is able to position each of the cassettes one by one like in a carousel to a unloading position (or more than one unloading positions) so that respective cassette can be aligned with the discharge device in an manner as described herein. The lift mechanism 100 may further comprise a controller (not shown in the figures) configured to control the actuators of the lift mechanism 103, the lateral displacement units and the opening mechanism 125 for controlling the same making it possible to unload a plurality of the cassettes (for instance four cassettes or even more) without essentially needing any operator intervention. In a further embodiment the housing of the lift mechanism 100 may placed on a self-propelled movable carriage (cart or the like) that may be controlled to exchange a lift system placed next to discharge device with a fully loaded new lift system once the cassettes of the former lift system have all been unloaded. In this manner even more cassettes can be unloaded without essentially needing any operator intervention.

Generally, in the arrangements described in connection with any of FIGS. 1-18, the cassette is aligned both the a first external device positioned at one end of the cassette housing and a second external device positioned at another (opposite) end of the cassette housing. However, in other embodiments, the arrangements of FIGS. 1-18 the cassette is aligned with one external device, either the first external device such as a container discharge device or the second external device such as a container push device.

It is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

1. A cassette for storing a tubular storage assembly, the tubular storage assembly comprising a plurality of elongated guiding elements onto which a plurality of rows of containers can be carried, wherein the elongated guiding elements are configured to be maintained in a substantially tubular arrangement while the containers extend in an interior space formed by the tubular arrangement, the cassette comprising:
a cassette housing configured to accommodate the tubular storage assembly, the elongated guiding elements of the tubular storage assembly extending in the axial direction of the cassette housing; and
a carrier arranged to be movable inside the cassette housing and configured to carry the tubular storage assembly;
wherein the cassette housing comprises at least one stop element for stopping movement of the carrier in the axial direction of the cassette housing and wherein the carrier and cassette housing are configured to allow the carrier to be essentially freely movable in transverse directions; and
wherein the carrier comprises at least one alignment element, wherein the at least one alignment element is configured to align the carrier relative to an external device to be arranged next to the cassette.

2. The cassette as claimed in claim 1, wherein the at least one alignment element of the carrier is configured to engage at least one alignment element of the external device.

3. The cassette as claimed in claim 1, wherein the carrier comprises at least one alignment element configured to align the carrier relative to a first external device arranged at a first end of the cassette and at least one other alignment element configured to align the carrier relative to a second external device arranged at a second end of the cassette.

4. The cassette as claimed in claim 1, wherein the at least one alignment element of the carrier is an alignment hole configured to receive an alignment pin from the external device and/or wherein the at least one alignment element of the carrier is an alignment pin configured to be inserted into an alignment hole provided in the external device.

5. (canceled)

6. The cassette as claimed in claim 4, wherein the at least one alignment hole has a lead-in part for guiding the alignment pin to be inserted in the alignment hole, the lead-in part preferably comprising a surface selected from the group consisting of a chamfered surface and a conical surface and/or wherein the at least one alignment pin has a chamfered part and wherein the lead-in part of the alignment hole and/or the chamfered part of the alignment pin are configured to move the carrier towards a predefined alignment position relative to the external device.

7. (canceled)

8. (canceled)

9. The cassette as claimed in claim 6, wherein the lead-in part of the alignment hole and/or the chamfered part of the alignment pin are configured to move the carrier in a transverse direction only towards a predefined alignment position, independent from a position of the cassette housing.

10. The cassette as claimed in claim 4, wherein the alignment pin is mounted so as to be movable between a retracted position wherein the alignment pin extends outside the alignment hole and an alignment position wherein the alignment pin is inserted in the alignment hole, optionally comprising a drive mechanism configured to move the alignment pin between the retracted position and the alignment position.

11. (canceled)

12. The cassette as claimed in claim 1, wherein a first alignment element is provided in a first end face of the cassette and a second alignment element is provided in a second end face of the cassette.

13. (canceled)

14. The cassette as claimed in claim 1, wherein the cassette housing comprises a first stop element and a second stop element arranged to abut respectively a first end face of the carrier and a second end face of the carrier.

15. The cassette as claimed in claim 1, comprising a first axial opening in a first end wall of the cassette housing for allowing a discharge of the containers from the cassette and/or a second axial opening in a second end wall of the cassette housing for allowing the application of a pushing force on the containers.

16. The cassette as claimed in claim 1, wherein the external device is a container discharge device configured to receive the containers from the tubular storage assembly into a receiving portion and to move removed containers from the receiving portion towards a discharge portion and/or wherein the external device is a container push device configured to push the containers and/or the tubular storage device in the axial direction of the cassette housing.

17. Cassette A cassette support system configured to support at least one cassette as claimed in claim 1, wherein the cassette support system further comprises a lift mechanism for lifting at least one of the at least one cassette relative to the external device.

18. The cassette support system as claimed in claim 17, wherein the lift mechanism is configured to lift the cassette housing and the carrier arranged therein so as to position the cassette housing substantially at a same height level as a height level of a first external device and a second external device when a first external device is arranged at a first end of the cassette and a second external device is arranged at a second end, opposite the first end, of the cassette.

19. (canceled)

20. The cassette support system as claimed in claim 17, wherein the lift mechanism is configured to arrange the cassette housing and the carrier arranged therein in a first position roughly aligned with at least one of a first external device and a second external device and wherein the alignment elements are configured to subsequently arrange the carrier in a second position accurately aligned with the at least one of the first external device and second external device.

21. The cassette support system as claimed in claim 20, wherein the alignment elements are configured to subsequently arrange the carrier in the second position with carrier movement being from a retracted position wherein an alignment pin extends outside an associated alignment hole to an alignment position wherein the alignment pin is inserted in the alignment hole.

22. The cassette support system as claimed in claim 17, wherein the cassette support is configured to carry a plurality of cassettes, wherein the lift mechanism is configured to position the cassettes one by one aligned with a discharge device and/or a push device wherein the cassette support system optionally comprises a carousel type lift mechanism.

23. (canceled)

24. (canceled)

25. A container assembly for storing the tubular storage assembly, the container assembly comprising:
a cassette as claimed in claim 1;
a cassette support system configured to support at least one cassette, wherein the cassette support system further comprises a lift mechanism for lifting at least one of the at least one cassette relative to the external device; and
a container discharge device comprising a receiving portion and a discharge portion, the discharge device being arranged next to an axial opening in an end wall of the cassette housing and being configured to receive containers from the tubular storage assembly in the receiving portion and move removed containers from the receiving portion towards the discharge portion;
wherein the carrier of the cassette comprises at least one first alignment element and the discharge device comprises at least one second alignment element, wherein the at least one first and second alignment elements are configured to displace the carrier and the tubular storage assembly thereon in a transverse direction relative to the cassette housing to align the carrier with the container discharge device.

26. The container assembly as claimed in claim 25, further comprising a push device arranged opposite a second axial opening in an end wall of the cassette housing and configured to apply a pushing force on the containers, wherein the carrier comprises at least one third alignment element and the push device comprises at least one fourth alignment element, wherein the at least one third and one fourth alignment elements are configured to displace the carrier and the tubular storage assembly thereon in the transverse direction relative to the cassette housing to align the carrier with the push device.

27. The container assembly as claimed in claim 25, wherein the discharge device further comprises:
a gripper unit; and
a drive configured to cause the storage assembly support and the gripper unit to rotate relative to each other;
wherein the gripper unit is configured to grip dispensing spouts of containers moved into the discharge device and successively passing by the gripper unit, to transport the gripped dispensing spouts and associated containers in essentially the axial direction of the cassette housing and to collect the dispensing spouts at the discharge portion.

28. The cassette support system as claimed in claim 17, wherein the lift mechanism is configured to lift the cassette housing and the carrier arranged therein so as to position the cassette housing substantially at a same height level as the external device.
